(19) United States
(12) Patent Application Publication
(10) Pub. No.: US 2017/0150699 A1
(43) Pub. Date: Jun. 1, 2017

(54) RIMMERS WITH COOLING ARRANGEMENTS

(71) Applicant: Ralph Whitman, Coleman, MI (US)

(72) Inventor: Ralph Whitman, Coleman, MI (US)

(21) Appl. No.: 15/350,452

(22) Filed: Nov. 14, 2016

Related U.S. Application Data
(63) Continuation of application No. 14/955,434, filed on Dec. 1, 2015.

(51) Int. Cl. A01K 13/00; B24B 23/02

(52) U.S. Cl. CPC A01K 13/00; B24B 23/02

(57) ABSTRACT

A device for trimming that is safe for the operator, is lightweight (hand held), and is configured such that the trimming head does not overheat. In one embodiment, it is comprised of a trimming head and in a second embodiment, it is comprised of a shank and a trimmer head combination, the air holes being configured through the trimming head. A third embodiment allows for a device to be threaded onto the shaft of a motorized power device.

### FIELD OF THE INVENTION

This invention deals primarily with a device that is hand held and which is used to trim various objects, for example, the toe nails of animals. The device is mechanized, driven by a motor, such as the well-known Dremel® equipment, or an electric drill. The component makeup of the instant device allows for the safe trimming of various objects.

### BACKGROUND OF THE INVENTION

Typically, those working in the industry of grooming pets have used scissors and anvil type clippers to trim toe nails, but quite often, the same individuals use hand held abrasive devices for the same job.

In recent times, some of those in the industry have turned to hand held trimmer devices that are mechanized rotary tools that hold abrasive tools. There are many problems associated with such hand held rotary devices in that they can overheat and cause discomfort to the animal. In addition, such devices can entangle long hair on animals, again at the discomfort of, if not, injury to the animals being groomed. In addition, rotary tools known in the prior art use beveled trimmer heads or purely circular trimming heads and these configurations tend to displace the nails while trimming.

One such device can be found in U.S. Pat. No. 4,854,334 issued to Su on Aug. 8, 1989 in which there is provided a power supply, a driving means, a switch means, a trimming means and a frame means for trimming nails.

Another device can be found in U.S. Pat. No. 7,428,881 that issued to Drelinger on Sep. 30, 2008 in which there is provided a device that is a rotary device that has a shroud and an opening in the shroud to allow an animal's nail to be put through the opening and shaped by the rotary grinder.

Drelinger discloses his invention again in U.S. Pat. No. 7,568,451,

### THE INVENTION

Thus, what is disclosed and claimed herein is a trimmer head, wherein the trimmer head has a forward end that has an outside edge, a rearward end, and an outer surface. The head has a long axis and is circular in configuration. The head contains on the outer surface, an abrasive material, the outside edge of the forward end is comprised of a radial configuration.

In another embodiment, there is a shank fixedly mounted essentially at a center point in a surface of the rearward end of the trimmer head. The shank comprises a near end and a distal end, wherein the near end is thicker in cross-section than the distal end. The distal end is configured to fit a motorized driving mechanism, the motorized driving mechanism not forming part of this invention.

In additional embodiments, there is a trimmer head wherein, in addition, there is a plurality of through holes through the trimmer head, paralleling the long axis; a trimmer head wherein, in addition, there is a plurality of through holes angled from the long axis; a trimmer head wherein, in addition, there is a plurality of through holes through the trimmer head perpendicular to the long axis; a trimmer head wherein, in addition, there is at least one circumferential groove in the trimmer head; a trimmer head wherein, in addition, there is a plurality of through holes through the trimmer head that are parallel to the long axis and there is at least one circumferential groove in the trimmer head; a trimmer head wherein, in addition, there is a plurality of through holes through the trimmer head, angled with respect to the long axis and, there is at least one circumferential groove in the trimmer head; a trimmer head wherein, in addition, there is a plurality of through holes through the trimmer head perpendicular to the long axis and there is at least one circumferential groove in the trimmer head; a combination of the trimmer head and the shank, wherein, in addition, there is a plurality of through holes through the trimmer head, paralleling the long axis; a combination wherein, in addition, there is a plurality of through holes angled from the long axis; a combination wherein, in addition, there is a plurality of through holes through the trimmer head perpendicular to the long axis; a combination wherein, in addition, there is at least one circumferential groove in the trimmer head; a combination wherein, in addition, there is a plurality of through holes through the trimmer head that are parallel to the long axis and there is at least one circumferential groove in the trimmer head; a combination wherein, in addition, there is a plurality of through holes through the trimmer head, perpendicular to the long axis and, there is at least one circumferential groove in the trimmer head; a combination wherein, in addition, there is a plurality of through holes through the trimmer head, angled with respect to the long axis and, there is at least one circumferential groove in the trimmer head; a trimmer head wherein, in addition, the trimmer head has a concave center portion; a trimmer head having a concave surface in combination with a shank, the shank being fixedly mounted essentially at a center point in a surface of the rearward end, the shank comprising a near end and a distal end, The near end being thicker in cross-section than the distal end, the distal end being configured to fit a motorized driving mechanism; a trimmer bead having a shank and a concavity wherein, in addition, there is a plurality of through holes through the trimmer head, paralleling said long axis; a trimmer head having a concave surface wherein, in addition, there is a plurality of through holes through the trimmer head, angled with respect to the long axis; a trimmer head having a concave surface wherein, in addition, there is a plurality of through holes through the trimmer head, perpendicular to the long axis; a trimmer head having a concave surface wherein, in addition, there is a plurality of through holes through the trimmer head, paralleling said long axis and there is at least one circumferential groove in the trimmer head; a trimmer head having a concave surface wherein, in addition, there is a plurality of through holes through the trimmer head, angled with respect to the long axis and, there is at least one circumferential groove in the trimmer head; a trimmer head having a concave surface wherein, in addition, there is a plurality of through holes through the trimmer head, perpendicular to the long axis and, there is at least one circumferential groove in the trimmer head; a combination of a trimmer head having a concave surface and a shank wherein, in addition, there is at least one circumferential groove in the trimmer head; a combination of a trimmer head having a concave surface and a shank wherein, in addition, there is a plurality of through holes through the trimmer head, paralleling the long axis; a combination of a trimmer head having a concave surface and a shank wherein, in addition, there is a plurality of through holes through the trimmer head, angled with respect to the long axis; a combination of a trimmer head having a concave surface and a shank wherein, in addition, there is a plurality of through holes through the trimmer head, perpendicular to the long axis; a combination of a trimmer head having a concave surface and a shank wherein, in addition, there is a plurality of through holes through the trimmer head paralleling the long axis and there is at least one circumferential groove in the trimmer head; a combination of a trimmer head having a concave surface and a shank wherein, in addition, there is a plurality of through holes through the trimmer head angled with respect to the long axis and, there is at lease one circumferential groove in the trimmer head; a combination of a trimmer head having a concave surface and a shank wherein, in addition, there is a plurality of through holes through the trimmer head perpendicular to the long axis and, there is at least one circumferential groove in the trimmer head.

### BRIEF DESCRIPTION OF THE DRAWINGS

FIG. 1 is a full side view of a device of this invention.

FIG. 2 is a full side view of another device of this invention.

FIG. 3 is a full side view of another embodiment of a device of this invention.

FIG. 4 is a full side view of another embodiment of a device of this invention.

FIG. 5 is a full side view of another embodiment of a device of this invention.

FIG. 6 is a full side view of another embodiment of a device of this invention.

FIG. 7 is a full side view of another embodiment of a device of this invention.

FIG. 8 is a full side view of another embodiment of a device of this invention.

FIG. 9 is a full side view of another embodiment of a device of this invention.

FIG. 10 is a full side view of another embodiment of a device of this invention.

FIG. 11 is a full side view of another embodiment of a device of this invention.

FIG. 12 is a full side view of another embodiment of a device of this invention.

FIG. 13 is a full side view of another embodiment of a device of this invention.

FIG. 14 is a full side view of another embodiment of a device of this invention.

FIG. 15 is a full side view of a trimming head of this invention.

FIG. 16 is a full side view of a trimming head of this invention.

FIG. 17 is a full side view of the internally threaded head of this invention.

FIG. 18 is a full end view of the device of FIG. 17.

FIG. 19 is a full side view of a device of this invention that is especially useful for human finger and toe nails.

FIG. 20 is a full side view of a device of this invention that is especially useful for boxer dog toenails.

### DETAILED DESCRIPTION OF THE DRAWINGS

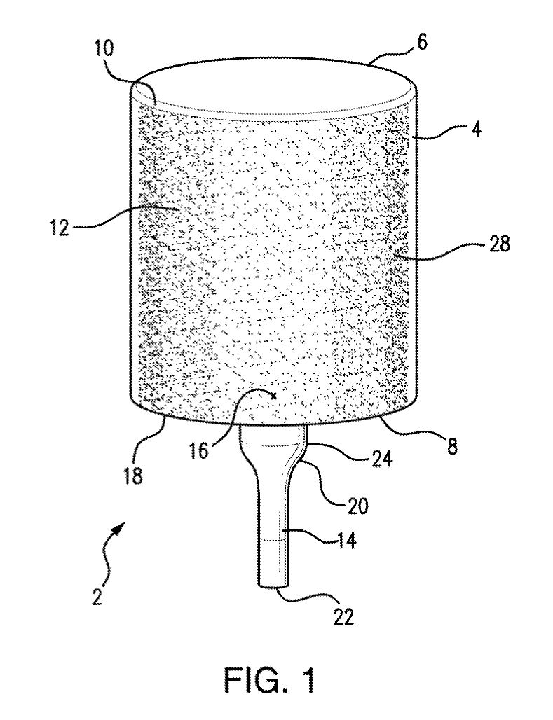

FIG. 1 is a full side view of a device 2 of this invention. The device 2 has a head portion 4 that has a forward end 6 and a rearward end 8. The rearward end 8 has rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. This motorized driving mechanism is the same type or similar to a drill or a Dremel device. There is also an outside edge 10. In this embodiment the outside surface 12 is an abrasive surface 28.

A variety of abrasive surfaces may be used in the invention herein, but in a preferred embodiment, the abrasive surface can be a surface bonded to the head. The abrasive can foe a coating such as spray on coatings, concave paper sanding bands, and the like. Preferably, an abrasive surface includes metal-bonded industrial diamond, for example, nickel-plated industrial diamond, yet others may prefer other methods of bonding and other abrasives. For example, others may prefer using a glue or composite to bond other abrasives or industrial diamond. Still, others may prefer other abrasives, for example, flint, garnet, emery, aluminum oxide, silicon carbide, alumina-zirconia, chromium oxide, ceramic aluminum oxide, or mixtures of any of them.

As long as the abrasive is hard enough to grind the nail of an animal, the abrasive will perform with some level or success. Alternatively, abrasive surface many be created by casting on of a material having abrasive properties, for example, a composite which includes abrasive material, or by texturizing the surface of the head, for example, by cutting fine grooves or notches into the surface of the head. All such embodiments are considered to be within the scope of the instant invention. Where particulate materials are used, the abrasive has a particle size of about 5000 grit to about 20 grit, based on Coated Abrasive Manufacturers Institute standards. More preferable, the abrasive size is about 150 to about 100, and most preferable is about 120.

It should be further noted that the outside edge 10 of the forward end 6 contains a radius configuration, or a rounded edge, such that long hairs and other similar objects will not be caught by the outside edge 10, and such an edge 10 will not cut or abrade the animal or the user.

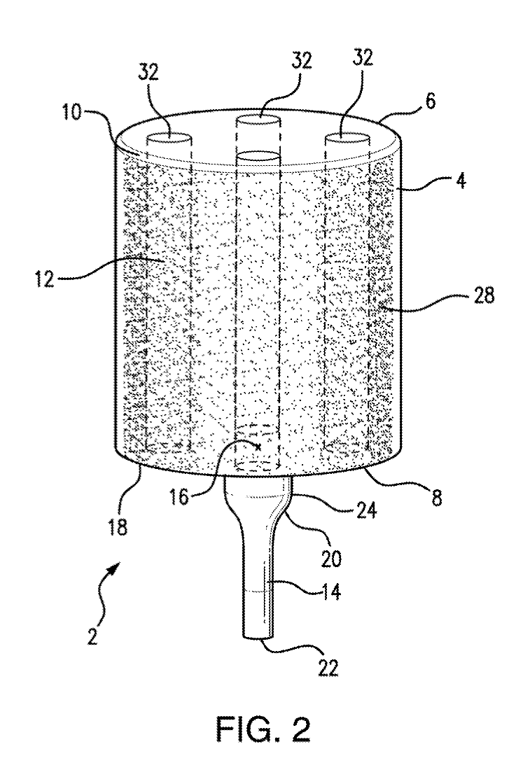

FIG. 2 is a full side view of one device 2 of this invention. This embodiment of the device 2 has a head portion 4 that has a forward end 6 and a rearward end 8. The rearward end 8 has a rearward surface 18 that has a center point 16 that shows the position of the shank 14. The shank 14 has a near end 20 and a distal end 22. The near end 20 of the shank 14 has a thicker portion 24 than the thinner distal end 22. The distal end 22 is configured to fit a motorized driving mechanism.

The outside surface 12 in this embodiment can be an abrasive material 28, such as, for example, diamond formed by electroplating. There are through holes 32 that extend from the forward end 6 through to the rearward end 8. These holes 32 are aligned from the forward end 6 to the rearward end 8 of the trimmer head 4. In this embodiment, it should be noted that the holes 32 are situated in the trimming head 4 such that they do not intercept the outside surface 12 of the trimming head 4. The holes 32 promote cooling of the trimmer head 4.

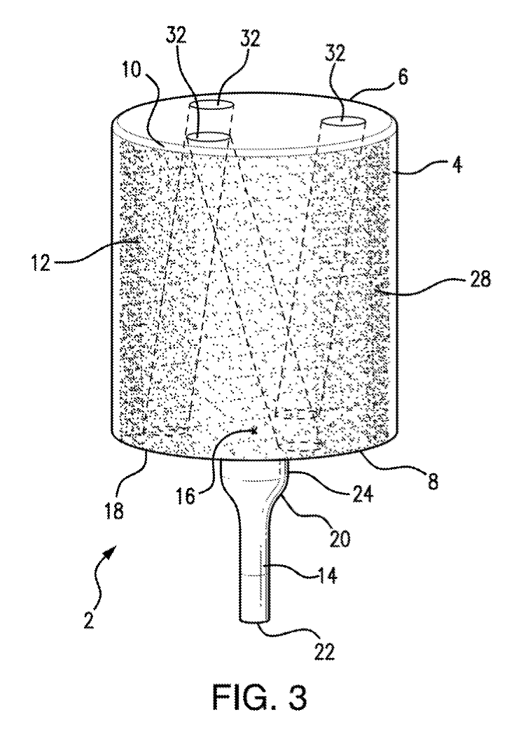

FIG. 3 is a full side view of another embodiment of the device 2. This embodiment of the device 2 has a head 4 portion that has a forward end 6 and a rearward end 8. The rearward end 8 has a rearward surface 18 that has a center point 16 that sows the position of the shank 14. The shank 14 has a near end 20 and a distal end 22. The near end 20 of the shank 14 has a thicker portion 24 than the thinner distal end 22. The distal end 22 is configured to fit a motorized driving mechanism.

In this embodiment, the holes 32 are angled from the forward end 6 to the rearward end 8 instead of being aligned parallel to the long axis of the head 4. As in the other embodiments the outside surface 12 is an abrasive surface 28.

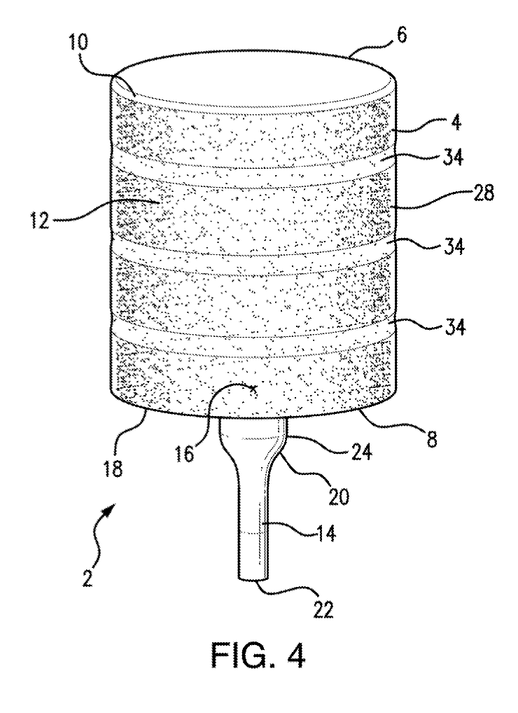

FIG. 4 is a full side view of another embodiment of the device 2. This embodiment of the device 2 has a head 4 portion that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. This embodiment contains at least one circumferential groove 34.

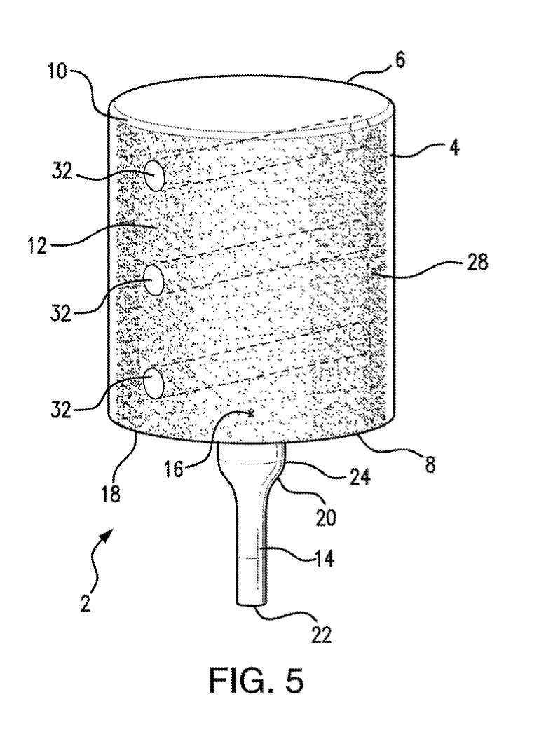

FIG. 5 is a full side view of another embodiment of the device 2. This embodiment of the device 2 has a head portion 4 that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. The holes 32 are aligned perpendicular to the long axis of the head. The holes 32 allow for trimmer head 4 cooling.

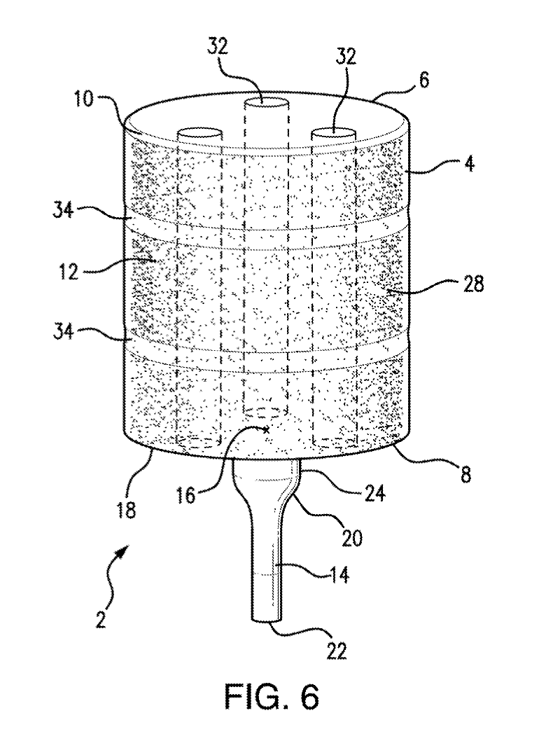

FIG. 6 is a full side view of another embodiment of the device 2. This embodiment of the device 2 has a head portion 4 that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. This embodiment also has an abrasive surface 28 on the outer surface 12.

There are circumferential grooves 34 milled into the trimming head 4 in a circumferential manner. These circumferential grooves 34 are milled such that they may intersect with the air holes 32. This configuration allows for even more air to flow through the trimming head 4 and helps alleviate heating of the trimming head 4 while in use.

The circumferential grooves 34 are nominally about 0.009 to about 0.90 inches thick and can vary in size according to the animal being treated. Preferred is about 0.024 inches. It is usually sufficient to allow one such circumferential groove 34, but this figure shows three such circumferential grooves 34 in the trimming head 4.

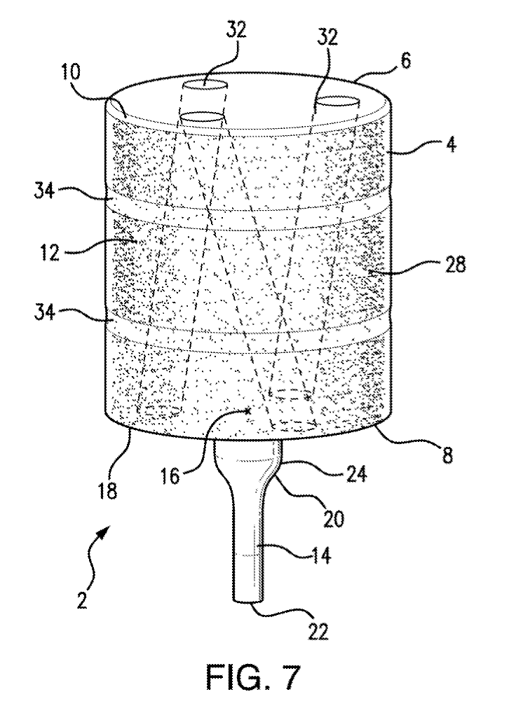

FIG. 7 is a full side view of another embodiment of the device 2. This embodiment of the device 2 has a head portion 4 that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. This embodiment also has an abrasive surface 28 on the outer surface 12.

This embodiment has holes 32 that are angled from the forward end 6 to the rearward end 8 instead of being aligned parallel to the long axis. As in the other embodiments the outside surface 12 has an abrasive surface 28.

There are circumferential grooves 34 milled into the trimming head 4 in a circumferential manner. These circumferential grooves 34 are milled such that they may intersect with the air holes 32. The holes 32 are angled. This configuration allows for even more air to flow through the trimming head 4 and helps alleviate heating of the trimming head 4 while in use.

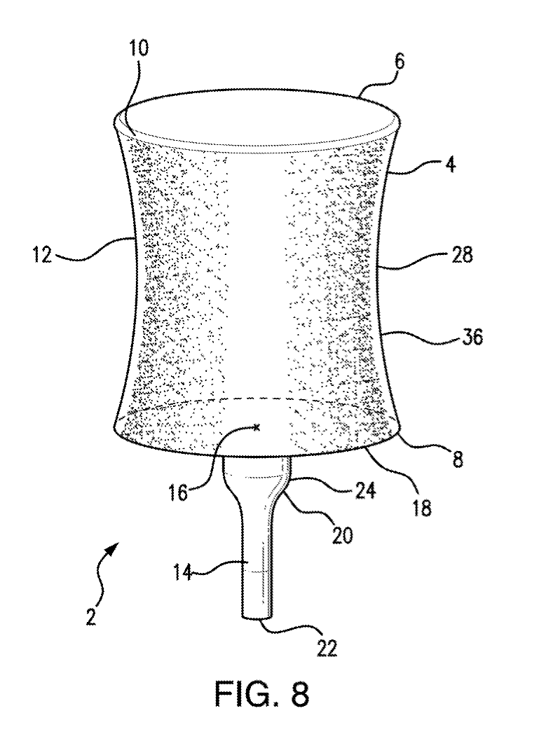

FIG. 8 is a full side view of another embodiment of the device 2. This embodiment of the device 2 has a head portion 4 that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. This embodiment also has an abrasive surface 28 on the outer surface 12.

In this embodiment the trimmer head 4 has a concave center portion 36. It should also be noted that this concave portion is radiused, that is, concave in the middle, to help keep toenails in place when grinding.

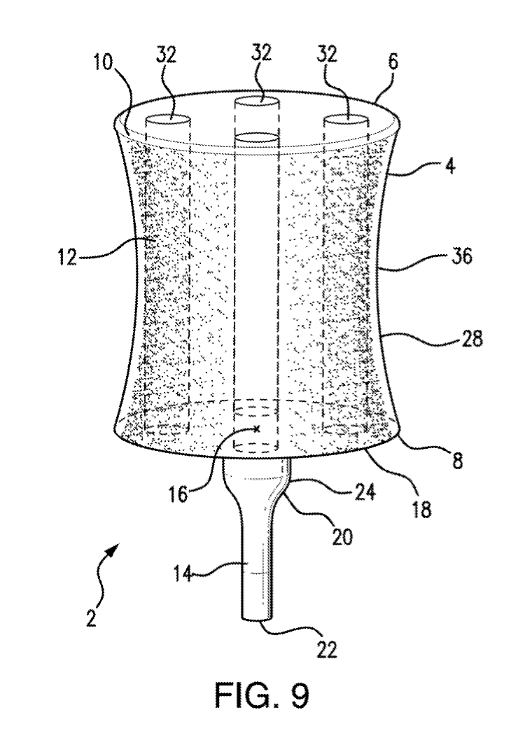

FIG. 9 is a full side view of another embodiment of the device 2. The device 2 has a head portion 4 that has a forward end 6 and a rearward end 8. The rearward end 8 has rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. This motorized driving mechanism is the same type or similar to a drill or a dremel. There is also an outside edge 10. In this embodiment the outside surface 12 is an abrasive surface 28.

There are through holes 32 that extend from the forward end 6 through to the rearward end 8. These holes 32 are aligned parallel to the long axis from the forward end 6 to the rearward end 8 of the head 4. In this embodiment, it should be noted that the holes 32 are situated in the trimming head 4 such that they may not intercept the outside surface 12 of the trimming head 4. The holes 32 promote cooling of the trimmer head 4.

It should be further noted that the outside edge 10 of the forward end 6 contains a radius configuration, or a rounded edge, such that long hairs and other similar objects will not be caught by the outside edge 10, and such an edge 10 will not cut or abrade the animal or the user.

In this embodiment the holes 32 are aligned from the forward end 6 to the rearward end 8 of the trimmer 2. It should be noted that the holes 32 are situated in the trimming head 4 such that they may not intercept the outside surface 12 of the trimming head 4.

It should be further noted that in this embodiment the trimmer head 4 has a concave center portion 36.

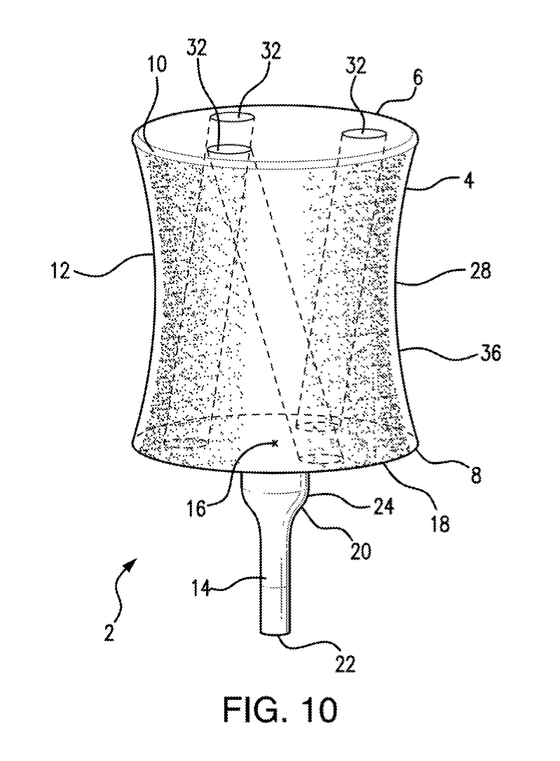

FIG. 10 is a full side view of another embodiment of the device 2. This embodiment of the device 2 has a head portion 4 that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism.

In this embodiment, the holes 32 are angled from the forward end 6 to the rearward end 8 instead of being aligned with the long axis. As in the other embodiments the outside surface 12 has an abrasive surface 28.

In this embodiment the holes 32 are aligned from the forward end 6 to the rearward end 8 of the device 2. In this embodiment, it should be noted that the holes 32 are situated in the trimming head 4 such that they may not intercept the outside surface 10 of the trimming head 4. The holes 32 promote cooling of the trimmer head 4.

It should be further noted that this embodiment the trimmer head 4 has a concave center portion 36.

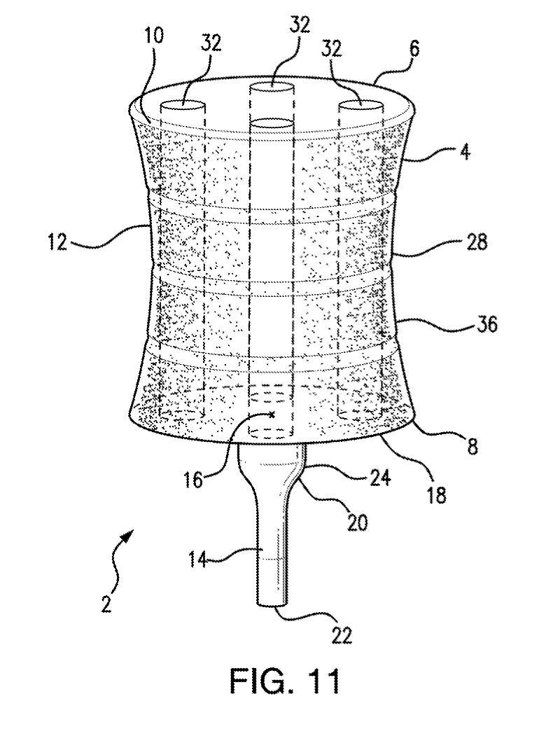

FIG. 11 is a full side view of another embodiment of the device 2. This embodiment of the device 2 has a head portion 4 that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. This embodiment also has an abrasive surface 28 on the outer surface 12.

There are through holes 32 that extend from the forward end 6 through to the rearward end 8. These holes 32 are aligned from the forward end 6 to the rearward end 8 of the trimmer 2. In this embodiment, it should, be noted that the holes 32 are situated in the trimming head 4 such that they may intercept the outside surface 12 of the trimming head 4. The holes 32 promote cooling of the trimmer head 4.

There are circumferential grooves 34 milled into the trimming head 4 in a circumferential manner. These circumferential grooves 34 are milled such that they intersect with the air holes 32. The holes 32 are vertical here. This configuration allows for even more air to flow through the trimming head 4 and helps alleviate heating of the trimming head 4 while in use.

It is usually sufficient to allow one such circumferential groove 34, but this Figure shows three such circumferential grooves 34 in the trimming head 4.

It should be further noted that this embodiment the trimmer head 4 has a concave center portion 36.

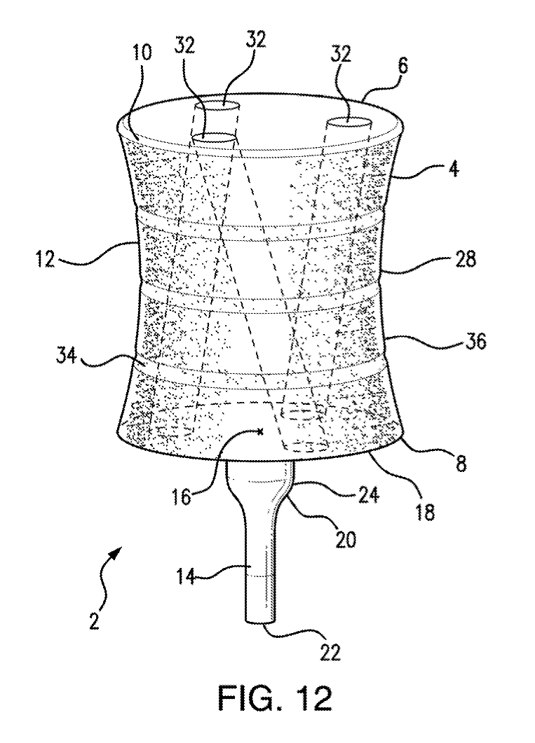

FIG. 12 is a full side view of another of the device 2. This embodiment of the device 2 has a head portion 4 that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. This embodiment also has an abrasive surface 28 on the outer surface 12.

This embodiment has the holes 32 are angled from the forward end 6 to the rearward end 8 instead of aligned along the long axis. As in the other embodiments the outside surface 12 has an abrasive surface 28.

There are circumferential grooves 34 milled into the trimming head 4 in a circumferential manner. These circumferential grooves 34 are milled such that they may intersect with the air holes 32. The holes 32 are angled here. This configuration allows for even more air to flow through the trimming head 4 and helps alleviate heating of the trimming head 4 while in use.

It should be further noted that this embodiment the trimmer head 4 has a concave center portion 36.

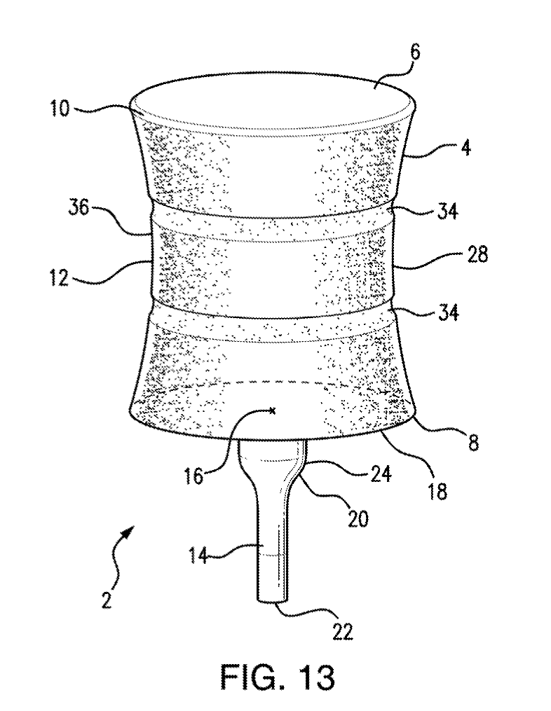

FIG. 13 is a full side view of another embodiment of the device 2. This embodiment of the device 2 has a head portion 4 that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. This embodiment contains circumferential grooves 34.

It should be further noted that this embodiment the trimmer head 4 has a concave center portion 36.

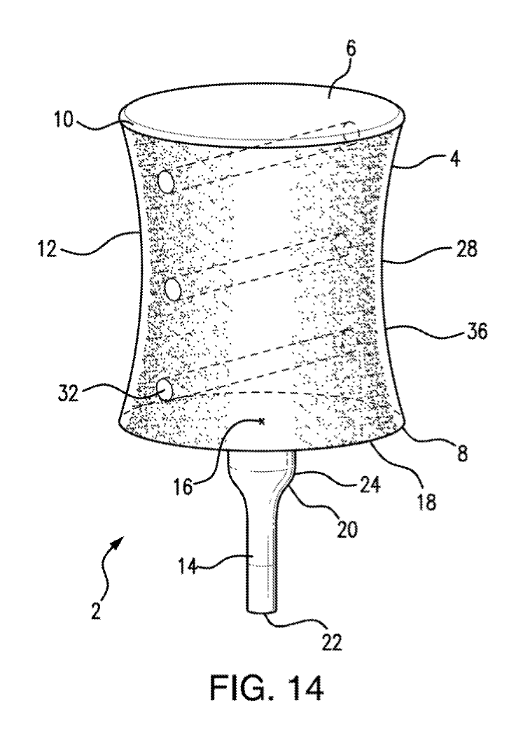

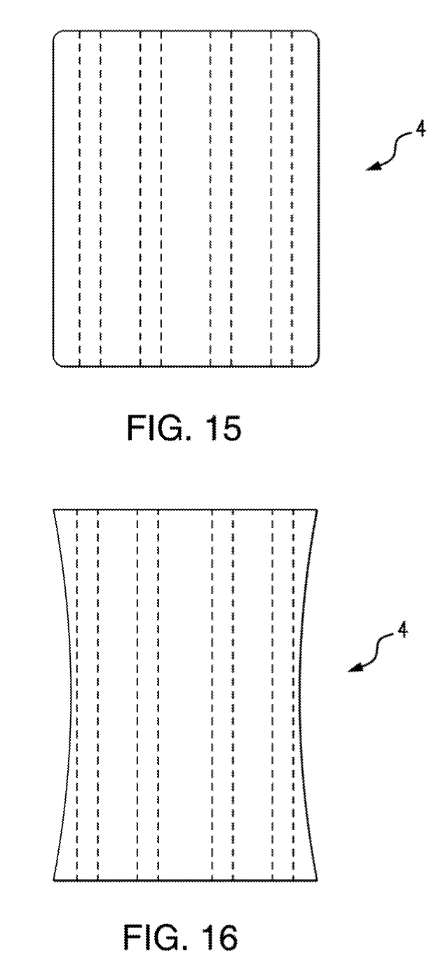

FIG. 14 is a full side view of the another embodiment of the trimmer 2. This embodiment of the trimmer 2 has a head 4 portion that has a forward end 6 and a rearward end 8. The rearward end 8 has a rearward surface 18 that has a center point 16 that contains the shank 14. The shank 14 has a near end 20 and a distal end 22. The near end 20 of the shank 14 has a thicker portion 24 than the thinner distal end 22. The distal end 22 is configured to fit a motorized driving mechanism. The holes 32 may pass through the outside surface 12. The holes 32 again allow for trimmer head 4 cooling.

It should foe further noted that this embodiment the trimmer head 4 has a concave center portion 36.

The shank 14 is normally a standard shank that fits rotary tools such as Dremel rotary tools, electric drills, and the like. The shank 14 is thicker near the rearward end 8 of the trimming head 4 to increase the strength of the shank 14.

The outside surface 12 of the trimming head 4 is an abrasive surface 28.

The air holes 32 in the trimming head 4 are placed there to convey air through the trimming head 6 to alleviate heating of the trimming head 4 while in use.

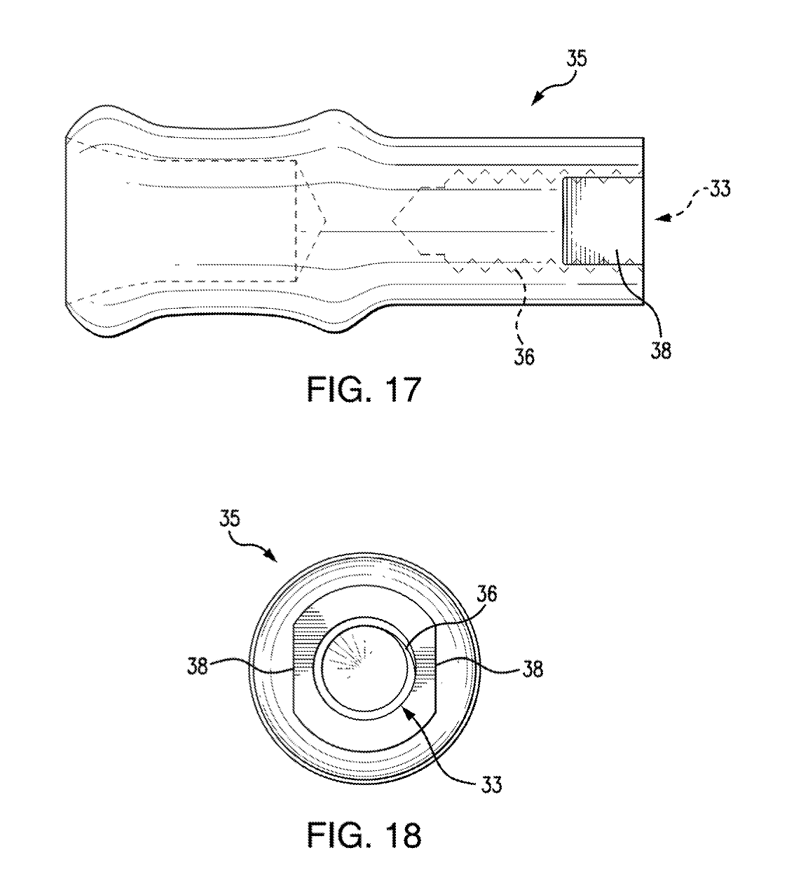

In another embodiment of the invention, there is shown in FIG. 17, a full side view of a device 35 that has internal threads 36. this device is especially useful in those power tools that have insufficient bearings in the drive end of the power tool. This device allows for diminishing the vibration of the head while being driven by the power tool. The insufficient bearings allow for a fair amount of vibration and this device will decrease or eliminate such vibration.

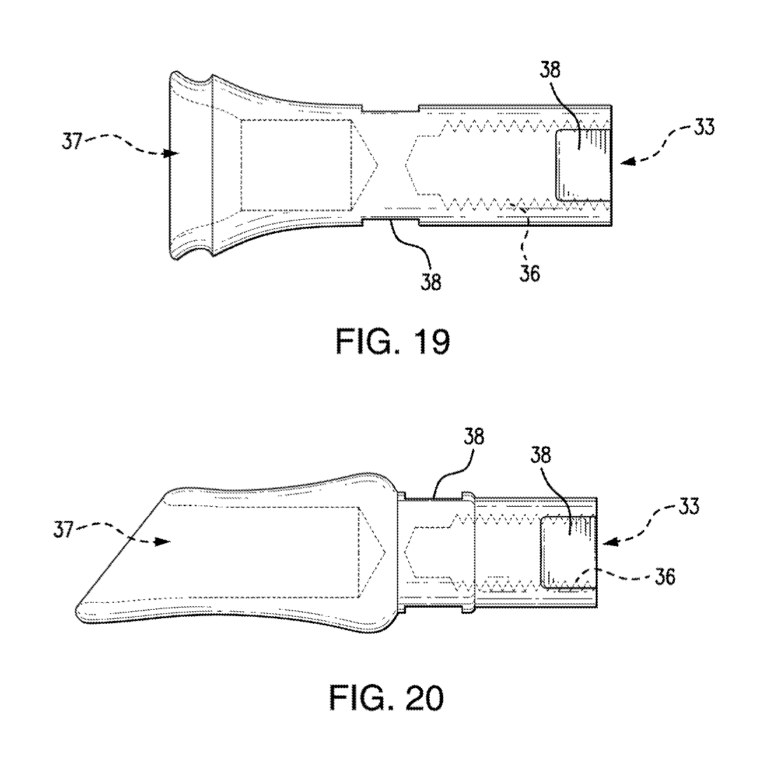

In use, the collet is removed from the power tool. The shaft of the power tool is threaded and thus will insert into the opening 33 of the devices of FIGS. 17, 19, and 20 and tighten therein. There is an additional opening 37 shown in phantom in FIGS. 17, 19, and 20. This opening 37 allows for air to move in and out of the device to cool it. Thus, there is shown in FIGS. 17, 18, 19, and 20, the shaft opening 33 and the internal threads 36, the openings and threads in the Figures being shown in Phantom.

It should be noted that there is a wrench pad 38 on each device 17, 19 and 20. There is an equivalent pad on the opposite side of the device. These two pads allow one to turn the device onto the shaft of the power tool and too remove the device from the power tool shaft.

Thus, the devices of the instant invention provide a means of trimming toenails of animals and humans that is safe for the operator, safe for the animal or human being treated, is lightweight (hand held), provides for maintaining toenails on the surface of the trimming head, and is configured such that the trimming head does not overheat.

There is no size limitation to the device, as it can be made to be hand held, or, for example, it can be large enough to use in oil drilling operations or in heavy machinery repair or manufacturing.

The number of openings or holes in each head can be as many as is desired by the user. There is no limitation with regard to the number of the holes in the head, or the size of the holes in the head, or the exact configurations of the holes in the head. Configurations can be, for example, as shown in the drawings herein, round, but they could be triangular, square, rectangular, octagonal, etc., depending on the desires of the user and objectives of use.

In addition, the particular angle from the long axis as recited herein is not critical and can foe any angle that will allow the air to pass through and cool the device and impair the end use of the device.

What is claimed is:

1. A trimmer head comprising:
a head, said head having a forward end having an outside edge, a rearward end, and an outer surface;
said head having a long axis;
said head being generally circular in configuration;
said head containing on said outer surface, an abrasive material, said outside edge of said forward end comprised of a radial configuration.

2. The trimmer head as claimed in claim 1 in combination with a shank, said shank being fixedly mounted essentially at a center point in a surface of said rearward end, said shank comprising a near end and a distal end, said near end being thicker in cross-section than said distal end, said distal end being configured to fit a motorized driving mechanism.

3. A trimmer head as claimed in claim 1 wherein, in addition, there is a plurality of through holes through said trimmer head, paralleling said long axis.

4. A trimmer head as claimed in claim 1 wherein, in addition, there is a plurality of through holes angled from said long axis.

5. A trimmer head as claimed in claim 1 wherein, in addition, there is a plurality of through holes through said trimmer head perpendicular to said long axis.

6. A trimmer head as claimed in claim 1 wherein, in addition, there is at least one circumferential groove in said trimmer head.

7. A trimmer head as claimed in claim 1 wherein, in addition, there is a plurality of through holes through said trimmer head that are parallel to said long axis and there is at least one circumferential groove in said trimmer head.

8. A trimmer head as claimed in claim 1 wherein, in addition, there is a plurality of through holes through said trimmer head, angled with respect to said long axis and, there is at least one circumferential groove in said trimmer head.

9. A trimmer head as claimed in claim 1 wherein, in addition, there is a plurality of through holes through said trimmer head perpendicular to said long axis and there is at least one circumferential groove in said trimmer head.

10. The combination as claimed in claim 2 wherein, in addition, there is a plurality of through holes through said trimmer head, paralleling said long axis.

11. The combination as claimed in claim 2 wherein, in addition, there is a plurality of through holes angled from said long axis.

12. The combination as claimed in claim 2 wherein, in addition, there is a plurality of through holes through said trimmer head perpendicular to said long axis.

13. The combination as claimed in claim 2 wherein, in addition, there is at least one circumferential groove in said trimmer head.

14. The combination as claimed in claim 2 wherein, in addition,, there is a plurality of through holes through said trimmer head that are parallel to said long axis and there is at least one circumferential groove in said trimmer head.

15. The combination as claimed in claim 2 wherein, in addition, there is a plurality of through holes through said trimmer head, perpendicular to said long axis and, there is at least one circumferential, groove in said trimmer head.

16. The combination as claimed in claim 2 wherein, in addition, there is a plurality of through holes through said trimmer head, angled with respect to said long axis and, there is at least one circumferential, groove in said trimmer head.

17. A trimmer head as claimed in claim 1 wherein, in addition, said trimmer head has a concave center portion.

18. The trimmer head as claimed in claim 17 in combination with a shank, said shank being fixedly mounted essentially at a center point in a surface of said rearward end, said shank comprising a near end and a distal end, said, near end. being thicker in cross-section than said distal end, said distal end being configured to fit a motorized driving mechanism.

19. A trimmer head as claimed in claim 17 wherein, in addition, there is a plurality of through holes through said head trimmer, paralleling said long axis.

20. A trimmer head as claimed in claim 17 wherein, in addition, there is a plurality of through holes through said trimmer head, angled with respect to said long axis.

21. A trimmer head as claimed in claim 17 wherein, in addition, there is a plurality of through holes through said trimmer head, perpendicular to said long axis.

22. A trimmer head as claimed in claim 17 wherein, in addition, there is a plurality of through holes through said trimmer head, paralleling said long axis and there is at least one circumferential groove in said trimmer head.

23. A trimmer head as claimed in claim 17 wherein, in addition, there is a plurality of through holes through said trimmer head, angled with respect to said long axis and, there is at least one circumferential groove in said trimmer head.

24. A trimmer head as claimed in claim 17 wherein, in addition, there is a plurality of through holes through said trimmer head, perpendicular to said long axis and, there is at least one circumferential groove in said trimmer head.

25. The combination as claimed in claim 18 wherein, in addition, there is at least one circumferential groove in said trimmer head.

26. The combination as claimed in claim 18 wherein, in addition, there is a plurality of through holes through said trimmer head, paralleling said long axis.

27. The combination as claimed in claim 18 wherein, in addition, there is a plurality of through holes through said trimmer head, angled with respect to said long axis.

28. The combination as claimed in claim 18 wherein, in addition, there is a plurality of through holes through said trimmer head, perpendicular to said long axis.

29. The combination as claimed in claim 18 wherein, in addition, there is a plurality of through holes through said trimmer head paralleling said long axis and there is at least one circumferential groove in said trimmer head.

30. The combination as claimed in claim 18 wherein, in addition, there is a plurality of through holes through said trimmer head angled with, respect to said, long axis and, there is at least one circumferential groove in said trimmer head.

31. The combination as claimed in claim 18 wherein, in addition, there is a plurality of through holes through said trimmer head perpendicular to said long axis and, there is at least one circumferential groove in said trimmer head.
